(19) United States
(12) Patent Application Publication
(10) Pub. No.: US 2025/0348976 A1
(43) Pub. Date: Nov. 13, 2025

(54) IMAGE PROCESSING METHOD AND DEVICE

(71) Applicant: Realtek Semiconductor Corporation, Hsinchu (TW)

(72) Inventors: Yu Cheng CHENG, Hsinchu (TW); Hsu-Tung SHIH, Hsinchu (TW); Yu-An CHANG, Hsinchu (TW)

(21) Appl. No.: 18/953,101

(22) Filed: Nov. 20, 2024

(30) Foreign Application Priority Data
May 9, 2024 (TW) 113117263

(51) Int. Cl. G06T 5/60

(52) U.S. Cl. CPC G06T 5/60; G06T 2207/20081; G06T 2207/20084

(57) ABSTRACT

An image processing method includes: training a first neural network model configured to execute a first image processing, according to multiple training data, to generate multiple first parameters associated with the first neural network model, in which the multiple first parameters includes multiple weights; training a second neural network model configured to execute a second image processing, which is different from the first image processing, according to the multiple training data and the multiple weights, to generate multiple second parameters associated with the second neural network model; and mixing the multiple first parameters with the multiple second parameters, to generate multiple blending parameters for a blending neural network model, in which the blending neural network model is configured to execute the first image processing and the second image processing on an input image, to output an optimized image.

### CROSS-REFERENCE TO RELATED APPLICATIONS

This application claims priority to Taiwan Application Number 113117263, filed May 9, 2024, which is herein incorporated by reference.

### BACKGROUND

### Field of Invention

The present disclosure relates to an image processing method and a device. More particularly, the present disclosure relates to an image processing method and a device based on a neural network processor.

### Description of Related Art

Because machine learning technology has the advantage of improving efficiency and accuracy for processing images, it has been a big trend in technology development to adopt neural network circuits to do image processings in recent years. On the other hand, the implement of image processings is usually not directed to a specific image effect and involves optimizing various image functions. Different image functions need to use different image processing circuits to do optimizing and each image processing circuit needs a neural network processor. Achieving the integrated image effect intended to have necessarily causes high hardware cost.

Therefore, the present disclosure is devoted to developing an image processing method and a device which processing various image effects with a single neural network circuit.

### SUMMARY

Some embodiments of the present disclosure are related to an image processing method, including: training a first neural network model configured to execute a first image processing, to generate multiple first parameters associated with the first neural network model, according to multiple training data, in which the multiple first parameters comprises a plurality of weights; training a second neural network model configured to execute a second image processing, to generate multiple second parameters associated with the second neural network model, according to the multiple training data and the multiple weights, in which the second image processing is different from the first image processing; and mixing the multiple first parameters with the multiple second parameters, to generate multiple blending parameters for a blending neural network model, in which the blending neural network model is configured to execute the first image processing and the second image processing on an input image, to output an optimized image.

Some embodiments of the present disclosure are related to an image processing method, including the following steps of: (a) training multiple neural network models in order, to generate a set of blending parameters for a blending neural network model, according to multiple sets of model parameters corresponding to the multiple neural network models, in which each of the multiple neural network models is configured to individually execute one of multiple image processings, and the blending neural network is configured to execute the multiple image processings according to the set of blending parameters; and (b) adjusting the set of blending parameters according to a set of output data of one of the plurality of neural network models and a blending loss function. The step (a) include: training a following neural network model of the multiple neural network models, according to multiple data and multiple weights of a set of model parameters of a preceding neural network model of the plurality of neural network models, to generate a set of model parameters of the following neural network model; and mixing the multiple sets of model parameters of the multiple neural network models to generate the set of blending parameters.

Some embodiments of the present disclosure are related to an image processing device, including a neural network processor which includes a blending neural network model configured to execute multiple image processings on an input image to output an optimized image. Multiple model parameters of the blending neural network model have a first proportion of multiple model parameters of a convolutional neural network model and a second proportion of multiple model parameters of a generative adversarial network model.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of an image processing device according to some embodiments of the present disclosure.

FIG. 2 is a schematic diagram of operations in a training method according to various embodiments of the present disclosure.

FIG. 3 is a flow diagram of an image processing method according to some embodiments of the present disclosure.

FIG. 4 is a flow diagram of an image processing method according to some embodiments of the present disclosure.

FIG. 5 is a schematic diagram of a blending loss function according to some embodiments of the present disclosure.

FIG. 6 is a flow diagram of an image processing method according to some embodiments of the present disclosure.

### DETAILED DESCRIPTION

Below the spirit of the present disclosure will be clearly illustrated by the drawings and the detailed description. Any variation or modification added by a person having ordinary skill in the art according to the technology taught in the present disclosure after he understood the embodiments of the present disclosure, still falls within the scope and spirit of the present disclosure.

The phrases as used herein just serve the goal of describing specific embodiments and are not intended to limit the present disclosure. Similarly, the singular articles “a”, “an”, “the”, and “this” herein include the multiple conditions as well.

As used herein, the terms “comprising,” “including,” “having,” “containing,” “involving,” and the like are to be understood to be open-ended, i.e., to mean including but not limited to.

Unless otherwise defined, all terms used herein have the same meanings as commonly understood by one of ordinary skill in the art to which this disclosure belongs, the content of the present disclosure, and the special content. Certain terms used to describe the present disclosure are discussed below or elsewhere in this specification to provide those skilled in the art with additional guidance in describing the present disclosure.

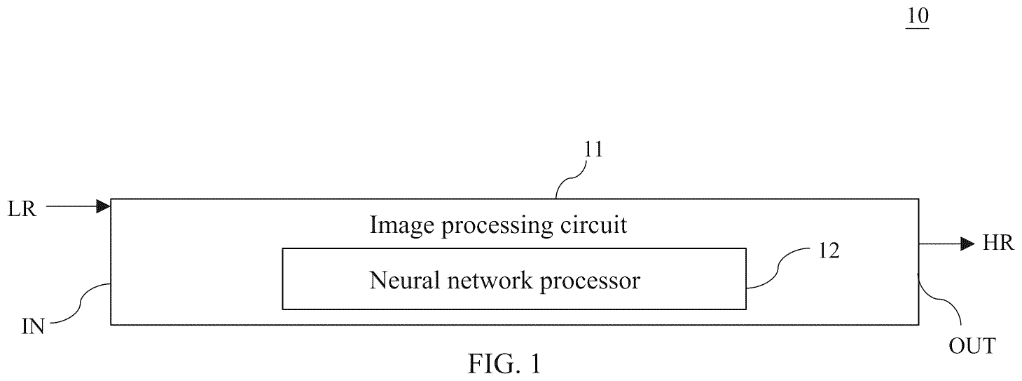

References are now made to FIG. 1. FIG. 1 illustrates a schematic diagram of an image processing device 10 according to some embodiments of the present disclosure. As shown in FIG. 1, the image processing device 10 in the present disclosure includes an image processing circuit 11 having a neural network processor 12, and is configured to execute multiple image processings on an input image LR received from the input terminal IN and output a corresponding optimized image HR.

In some embodiments, the image processing circuit 11 can be integrated circuits of various circuit components in charge of image processings. In some embodiments, the neural network processor 12 can be a graphic processing unit (GPU), a field-programmable gate array (FPGA), or an application specific integrated circuit (ASIC).

In some embodiments, a neural network model in the image processing circuit 11 is configured to execute image processings, such as suppressing noise, increasing image details, improving sharpening, raising contrast, etc., on the input image LR, to generate the optimized image HR.

In some embodiments, the image processing device 10 fabricated, through programming a blending neural network model 140 generated by using an image processing method 300,400, or 600, which is described in the following paragraphs, in the neural network processor 12, can be configured to execute multiple image processings.

By using the image processing device 10 in the present disclosure, multiple image effects can be processed by the single neural network processor, and thereby, the hardware cost can be reduced. It is because the present disclosure first trains a neural network model capable of executing multiple image processings by using deep learning technology, and then realizes the neural network model in hardware. The training method will be detailed as follows.

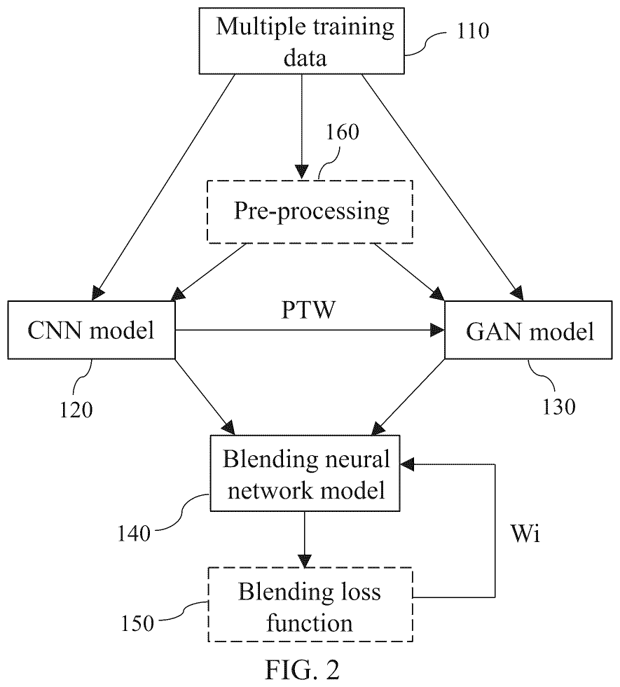

References are now made to FIG. 2. FIG. 2 illustrates a schematic diagram of operations in a training method of the neural network model corresponding to the neural network processor 12 in FIG. 1 according to various embodiments of the present disclosure. In some embodiments, the training for the neural network model in the neural network processor 12 in FIG. 1 involves multiple training data 110, a convolutional neural network (CNN) model 120, a generative adversarial network (GAN) model 130, and a blending neural network model 140. In some embodiments, the training for the neural network mode in the neural network processor 12 in FIG. 1 can involve pre-processing 160 as well.

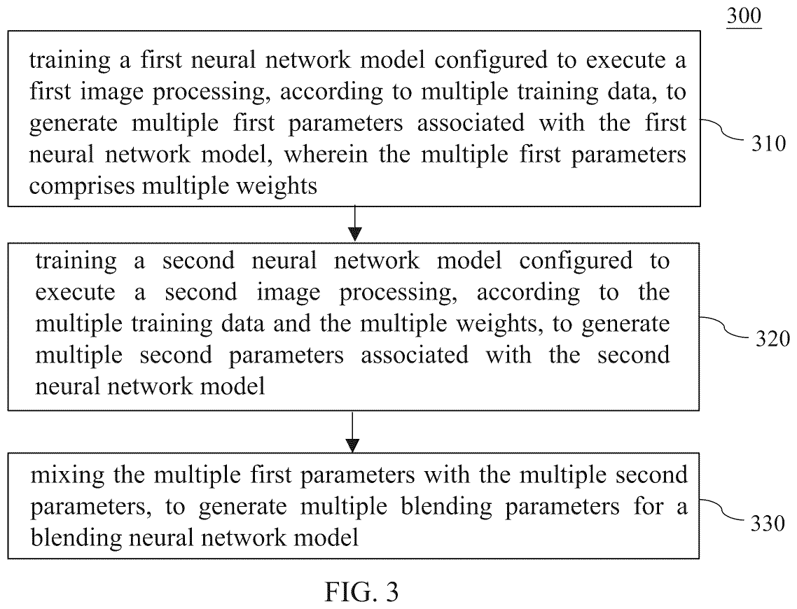

References are now made to FIG. 2 and FIG. 3 together, in which FIG. 3 is a flow diagram of an image processing method 300 according to some embodiments of the present disclosure. It is understood that additional steps may be implemented before, during, and after the image processing method 300 shown in FIG. 3, and some of the steps described below may be replaced or eliminated for additional embodiments of the image processing method 300. The order of steps/methods can be exchanged. In each drawing and illustrative embodiments, like reference numbers are used to designate like elements. The image processing method 300 includes steps 310-330 with reference to the training method in FIG. 2.

In the step 310, as shown in FIG. 2, the CNN model 120 configured to execute a first image processing (such as suppressing noise) is trained according to multiple training data 110, to generate multiple CNN model parameters associated with the CNN model 120.

In some embodiments, multiple training data 110 includes multiple non-golden data and multiple golden data. The non-golden data correspond to the input image LR while the golden data correspond to the image which the input image LR will imitate through the training (i.e., the output image HR which the image processing device 10 will output in correspondence to the input image LR). Thus, the non-golden data and the gold data correspond to each other one to one. Alternatively stated, when the non-golden data is x1, x2 . . . xn}, correspondingly, the gold data is {X1, X2 . . . . Xn}.

Specifically, the training data 110 (which are the gold data and the non-golden data) is inputted into the CNN model 120. Then, the computation is done on the training data with the algorithm of the CNN model 120, according to the general deep learning approach, and the CNN model parameters including {a1, a2 . . . an} are outputted, in which a1 to an are weights PTW of the CNN model and correspond to the training data x1 to xn, respectively. In some embodiments, the CNN model can further include a bias a0.

In the step 320, as shown FIG. 2, the GAN model 130 configured to execute the second image processing (such as generating image details) is trained, according to the training data 110 and the weights PTW, to generate multiple GAN model parameters associated with the GAN model. In similarity with the training for the CNN model, in addition to inputting the multiple training data 110 into the GAN model 130, the training for the GAN model 130 includes taking the weights PTW as pre-trained weights of GAN model 130 to input into the GAN model 130.

Particularly, the GAN model 130 includes a generator and a discriminator. The step of inputting the multiple training data 110 into the GAN model 130 mentioned above includes inputting the non-golden data into the generator and inputting the golden data into the discriminator. In each iteration of training the GAN model 130, the generator generates multiple output data corresponding to non-golden data; then, the discriminator further compare the output data with the golden data; when discriminator determine the output data are different from the golden data, the current weights of the GAN model are updated; and when the discriminator cannot distinguish the golden data from the output data, the training for the GAN model 130 ends and the GAN model parameters including {b1, b2 . . . bn} are outputted, in which b1 to bn are the weights of the GAN model and correspond to the training data x1 to xn, respectively. In some embodiments, the GAN model can further include a bias b0.

In the step 330, as shown in FIG. 2, the CNN parameters are mixed with the GAN parameters, to generate multiple blending parameters for the blending neural network model. The blending neural network model 140 in which the blending parameters are inputted can output the optimized image HR having the blending image processing effect of the CNN model 120 and the GAN model. The method of generating the blending parameters for the blending neural network model 140 is specifically described as follows.

For example, the training mentioned above generates a set of CNN model parameters {a1, a2 . . . an} and a set of GAN model parameters {b1, b2 . . . bn}. Each of the CNN model parameters can be mixed with corresponding one of the GAN model parameters in a proportion as follows:

$$\{ c 1 … cn \} , having cm = {α}_{p} * a m + ( 1 - {α}_{p} ) * b m , m = 1 , 2 … n .$$

αₚ is a constant between 0 and 1. αₚ is determined according to the desirable image processing effect. For example, αₚ that is greater than 0.5 can be used when the effect of suppressing that noise is amplified is preferred.

When the CNN model parameters and the GAN model parameters further include biases, mixing parameters mentioned above further include mix the bias of the CNN model a0 and the bias of the GAN model b0. In correspondence to the mixing method in a proportion mentioned above, the blending parameters further include a blending bias c0:

$$c 0 = {α}_{p} * a 0 + ( 1 - {α}_{p} ) * b 0 .$$

In some embodiments, the blending neural network model 140 is a CNN model. In other embodiments, the blending neural network model 140 is a GAN model.

Although the training method is illustrated through the blending of the CNN model and the GAN model 130 above, the training method of the present disclosure is not limited to implementing the blending of the CNN model 120 and the GAN model 130. In some embodiments, the GAN model 130 can be replaced with another CNN model, i.e., two CNN models for different image processings are used (In addition to suppressing noise, in general, the CNN model can be configured to execute the image processings such as sharpening, deblurring, improving resolution, etc., which depends on the design of the algorithm). In some embodiments, the CNN model 120 and/or the GAN model 130 can be replaced with a deep neural network (DNN) model or a Recurrent Neural Network (RNN) model. In some embodiments, the CNN model 120 and/or the GAN model 130 can be replaced with an unsupervised neural network model and the training data 110 need not to include golden data in the meantime.

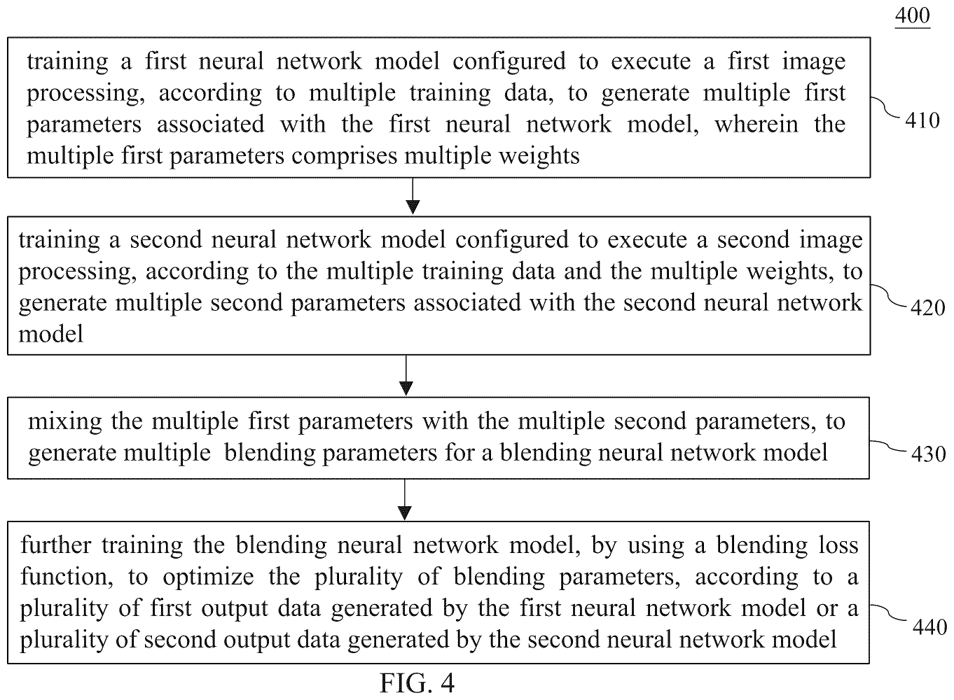

Reference is now made to FIG. 2 and FIG. 4 together, in which FIG. 4 is a flow diagram of an image processing method 400 according to some embodiments of the present disclosure. It is understood that additional steps may be implemented before, during, and after the image processing method 400 shown in FIG. 4, and some of the steps described below may be replaced or eliminated for additional embodiments of the image processing method 400. The order of steps/methods can be exchanged. In each drawing and illustrative embodiments, like reference numbers are used to designate like elements. The image processing method 400 includes steps 410-440. In the image processing method 400, the step 410, 420, and 430 are similar to the steps 310, 320, and 330 in the image processing method 300, and thus, the repetitious descriptions are omitted here.

In the step 440, as shown in FIG. 4, the blending neural network model 140 is further trained by using the blending loss function 150, according to multiple first output data generated by the CNN model 120 or multiple second output data generated by the GAN model 130, to optimize the blending parameters of the blending neural network model 140.

In some embodiments, when the blending neural network model 140 is a CNN model, the first output data received from the CNN model 120 is inputted in the blending neural network model 140, and the blending neural network model 140 is further trained by using the blending loss function 150. In each iteration of training the blending neural network model 140, the blending neural network model 140 generates multiple optimized data according to the first output data, and inputs the optimized data in the blending loss function 150 to calculate a magnitude of the blending loss function 150, and whether the weights Wi of the blending neural network model 140 are further adjusted is determined according to the magnitude of the blending loss function 150.

For example, when the magnitude of the blending loss function 150 is calculated as greater than a threshold value, the magnitude of the weights are adjusted and the updated weights Wi are inputted in the blending neural network model 140 again to execute next iteration. In contrast, when the magnitude of the blending loss function 150 is calculated as less than the threshold value, the training of the blending neural network model 140 ends, and the current weights Wi are taken as the blending parameters of the blending neural network model 140.

When the blending neural network model 140 is a GAN model, the second output data received from the GAN model 130 is inputted in the blending neural network model 140, and the blending neural network model 140 is further trained by using the blending loss function 150. In comparison with the embodiments in which the blending neural network model 140 is a CNN model, the training method of the embodiments in which the blending neural network model 140 is a GAN model is the same except that the first output data are replaced with the second output data, and thus, the repetitious descriptions are omitted here.

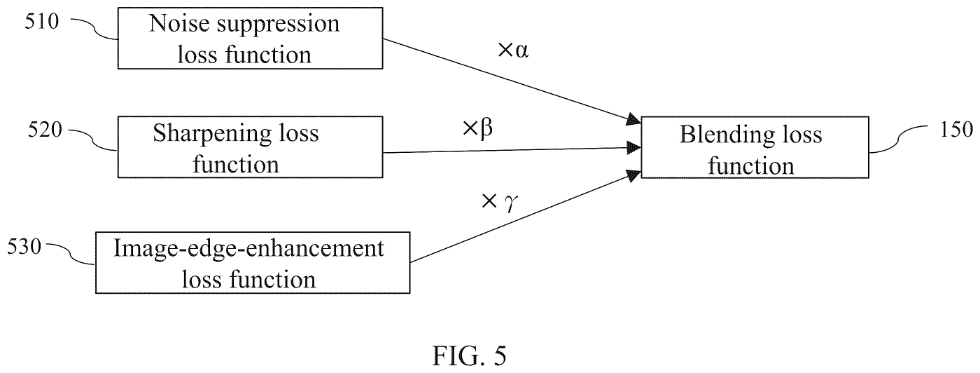

In some embodiments, the blending loss function is as shown in FIG. 5. The blending loss function 150 can be designed according to the required image optimization effect. Specifically, the blending loss function 150 can be a noise suppression loss function 510, a sharpening loss function 520, an image-edge-enhancement loss function 530, or a combination thereof.

In some embodiments, the blending loss function 150 is linear superposition of a plurality of loss functions. For example, as shown in FIG. 5, the blending loss function 150 is generated by superposing the noise suppression loss function 510, the sharpening loss function 520, and the image-edge-enhancement loss function 530 in a proportion of a: B: Y. Alternatively stated, when the values of the noise suppression loss function 510, the sharpening loss function 520, and the image-edge-enhancement loss function 530 are f(x1, x2 . . . xn), g(x1, x2 . . . xn), and h(x1, x2 . . . xn), respectively, the value of the blending loss function BLF(x1, x2 . . . xn) is:

$$BLF ( x 1 , x 2 … xn ) = α * f ( x 1 , x 2 … xn ) + β * g ( x 1 , x 2 … xn ) + γ * h ( x 1 , x 2 … xn ) ,$$

in which α, β, and γ are determined according to the required image effect, for example, β is increased if the sharpening effect is preferred.

More particularly, in the embodiments mentioned above, because the scales of f(x1, x2 . . . xn), g(x1, x2 . . . xn), and h(x1, x2 . . . xn) are different, a balancing act is first done before α, β, and γ are determined, to make the contributions of the noise suppression loss function 510, the sharpening loss function 520, and the image-edge-enhancement loss function 530 to the blending loss function 150 comparable. Alternatively stated, the scales of f(x1, x2 . . . xn), g(x1, x2 . . . xn), and h(x1, x2 . . . xn) are calculated to determine the initial values of α, β, and γ to make the products of the initial value and the function corresponding to α, β, and γ comparable, i.e., the orders of the scales of the products α*f(x1, x2 . . . xn) [symbol] β*g(x1, x2 . . . xn) [symbol] and γ*h(x1, x2 . . . xn) are the same. Then, the magnitudes of α, β, and γ are adjusted based on the initial values.

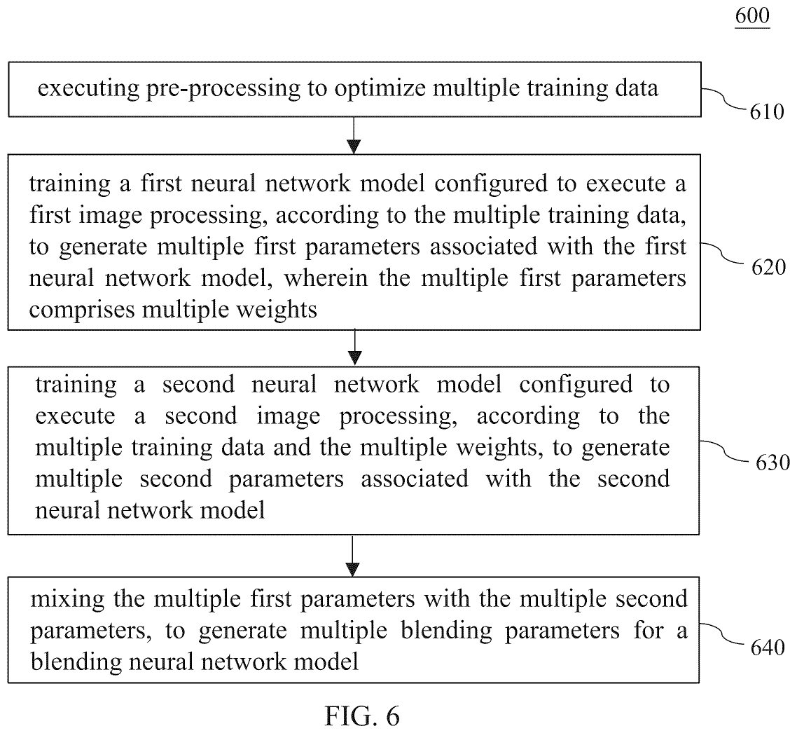

Reference is now made to FIG. 2 and FIG. 6 together, in which FIG. 6 is a flow diagram of an image processing method 600 according to some embodiments of the present disclosure. It is understood that additional steps may be implemented before, during, and after the image processing method 600 shown in FIG. 6, and some of the steps described below may be replaced or eliminated for additional embodiments of the image processing method 600. The order of steps/methods can be exchanged. In each drawing and illustrative embodiments, like reference numbers are used to designate like elements. The image processing method 600 includes steps 610-640. In the image processing method 600, the step 620, 630, and 640 are similar to the steps 310, 320, and 330 in the image processing method 300, and thus, the repetitious descriptions are omitted here.

In the step 610, as shown in FIG. 6, the pre-processing 160 is executed to optimize the multiple training data 110. Before training the CNN model 120, the pre-processing 160 is executed on the golden data of the training data to optimize the golden data.

In some embodiments, the pre-processing 160 is a denoising process, a sharpening process, or an edge enhancement process. In some embodiments, the pre-processing 160 includes a denoising process, a sharpening process, and an edge enhancement process. The pre-processing can be configured to replace the blending loss function 150 mentioned above. Alternatively stated, there is no need to further train the blending neural network model 140 by using the blending loss function 150, if the pre-processing is executed. The methods of using the pre-processing 160 and the blending loss function 150 can obtain the same or approximate image processing effect, and both reduce the hardware cost.

Although all of the embodiments mentioned above involve the blending of only two neural network models, it is understood that the image processing methods 300, 400, and 600 can be applicable to the blending of more neural network models which execute different image processings as well. By using the training method for the GAN model 130 in the image processing methods 300, 400, and 600, i.e. training the following neural network model according to the training data and the weights of the preceding neural network model, the subsequent third, fourth . . . etc., neural network models are trained to generate multiple model parameters and multiple output data of the third, fourth . . . etc., neural network models.

Correspondingly, after the training is completed, in similarity with the image processing methods 300, 400, and 600, the model parameters are mixed with the CNN model parameters and the GAN model parameters to generate multiple blending parameters for the blending neural network model 140.

In similarity with the image processing method 400, the blending parameters can be further adjusted according to the output data of one of the trained neural network models and the blending loss parameters. On the other hand, the training order of the neural network models is determined according to convergence difficulty. For example, the training of the CNN model converges more easily than the training of the GAN model, and thus, the CNN model is trained first. For another example, when the preceding neural network model and the following neural network model are the same model type, the training of the following neural network model converges more easily, and thus, the neural network model of the model type that is the same as the preceding neural network is trained subsequent to the preceding neural network model. For example, three models including the first CNN model, the second CNN model, and the GAN model are now trained. In some embodiments, the first CNN model is first trained, the second CNN model is then trained, and the GAN model is finally trained. In some embodiments, the second CNN model is first trained, the first CNN is then trained, and the GAN model is finally trained. However, it should be avoided that the first CNN model is first trained, the GAN model is then trained, and the second CNN model is finally trained so as to speed down the convergence.

Although the embodiments mentioned above of the present disclosure focus on the image processing, it is understood that the present disclosure can also be applicable to the processings of audio, voice, text, etc. . . .

In view of the above, the present disclosure generates the neural network model having multiple image processing functions through deep learning technology and then implements the hardware realization, indeed offering a route to reduce the hardware cost sufficiently.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An image processing method, comprising:
training a first neural network model configured to execute a first image processing, according to a plurality of training data, to generate a plurality of first parameters associated with the first neural network model, wherein the plurality of first parameters comprises a plurality of weights;
training a second neural network model configured to execute a second image processing, according to the plurality of training data and the plurality of weights, to generate a plurality of second parameters associated with the second neural network model, wherein the second image processing is different from the first image processing; and
mixing the plurality of first parameters with the plurality of second parameters, to generate a plurality of blending parameters for a blending neural network model, wherein the blending neural network model is configured to execute the first image processing and the second image processing on an input image, to output an optimized image.

2. The image processing method of claim 1, further comprising:
generating a plurality of first output data, through the first neural network model, after training the first neural network model is completed;
generating a plurality of second output data, through the second neural network model, after training the second neural network model is completed; and
further training the blending neural network model, by using a blending loss function, to optimize the plurality of blending parameters.

3. The image processing method of claim 2, wherein the first neural network mode is different from the second neural network model, wherein the image processing method further comprises one of following steps:
training the blending neural network model, according to the plurality of first output data, when the blending neural network model and the first neural network model are of the same model type; and
training the blending neural network model, according to the plurality of second output data, when the blending neural network model and the second neural network model are of the same model type.

4. The image processing method of claim 2, wherein the blending loss function is linear superposition of a plurality of loss functions.

5. The image processing method of claim 4, wherein the plurality of loss functions comprise at least one of a noise suppression loss function, a sharpening loss function, and an image-edge-enhancement loss function.

6. The image processing method of claim 2, wherein the blending loss function is a noise suppression loss function, a sharpening loss function, or an image-edge-enhancement loss function.

7. The image processing method of claim 1, further comprising:
executing pre-processing to optimize the plurality of training data, before training the first neural network model.

8. The image processing method of claim 7, wherein the pre-processing comprises a denoising process, a sharpening process, and an edge enhancement process.

9. The image processing method of claim 1, wherein the first neural network model is a convolutional neural network model.

10. The image processing method of claim 1, wherein the second neural network model is a generative adversarial network model.

11. The image processing method of claim 10, wherein the plurality of training data comprises a plurality of first data and a plurality of second data, and the generative adversarial network model comprises a generator and a discriminator, and the image processing method further comprising, in each iteration of training the generative adversarial network model:
generating, by the generator, a plurality of output data corresponding to the plurality of first data; and
comparing, by the discriminator, the plurality of output data with the plurality of second data.

12. The image processing method of claim 1, wherein the first neural network model is a convolutional neural network, and the second neural network model is a generative adversarial network model.

13. The image processing method of claim 1, wherein the blending neural network model is a convolutional neural network model or a generative adversarial network model.

14. The image processing method of claim 1, wherein each of the plurality of second parameters mix corresponding one of the plurality of first parameters in a proportion.

15. An image processing method, comprising:
training a plurality of neural network models in order, to generate a set of blending parameters for a blending neural network model, according to a plurality of sets of model parameters corresponding to the plurality of neural network models, wherein each of the plurality of neural network models is configured to individually execute one of a plurality of image processings, and the blending neural network model is configured to execute the plurality of image processings according to the set of blending parameters, comprising:
training a following neural network model of the plurality of neural network models, according to a plurality of training data and a plurality of weights of a set of model parameters of a preceding neural network model of the plurality of neural network models, to generate a set of model parameters of the following neural network model; and
mixing the plurality of sets of model parameters of the plurality of neural network models to generate the set of blending parameters; and
adjusting the set of blending parameters according to a set of output data of one of the plurality of neural network models and a blending loss function.

16. The image processing method of claim 15, further comprising:
determining a training order of the plurality of neural network models according to convergence difficulty.

17. An image processing device, comprising:
a neural network processor, comprising:
a blending neural network model configured to execute a plurality of image processings on an input image to output an optimized image,
wherein a plurality of model parameters of the blending neural network model have a first proportion of a plurality of model parameters of a convolutional neural network model and a second proportion of a plurality of model parameters of a generative adversarial network model.

18. The image processing device of claim 17, wherein the plurality of model parameters of the generative adversarial network model are correlated with the plurality of model parameters of the convolutional neural network model.
